(19) United States
(12) Patent Application Publication
(10) Pub. No.: US 2013/0217810 A1
(43) Pub. Date: Aug. 22, 2013

(54) Surface Treating Agent Containing a Film Forming Resin Composition as Well as Fillers, and Use Thereof

(71) Applicants: Ulmadan-R.D. ApS, (US); HOMAG HOLZBEARBEITUNGSSYSTEME AG, (US)

(72) Inventor: Uffe Laursen, Kerteminde (DK)

(73) Assignees: HOMAG HOLZBEARBEITUNGSSYSTEME AG, Schopfloch (DE); Ulmadan-R.D. ApS, Kerteminde (DK)

(21) Appl. No.: 13/709,640

(22) Filed: Dec. 10, 2012

Related U.S. Application Data
(63) Continuation of application No. 13/503,610, now abandoned.

(30) Foreign Application Priority Data
Oct. 23, 2009 (DK) PA 2009 01148
Oct. 23, 2009 (DK) PA20090114823

(51) Int. Cl. C09D 135/02

(52) U.S. Cl. CPC C09D 135/02
USPC 524/13; 524/559; 524/494; 524/401; 524/426

(57) ABSTRACT

A surface treating agent (8) containing a film forming resin composition (2) and a filler (3), said filler comprising a particulate material selected from inorganic acids, chalk (CaCO3), glass, plastics, wood flour or combinations thereof. The filler (3) has a particle size of below 400 hm. The surface treating agent (8) is used particularly for application to faces and/or edges of plate-shaped elements (4) of solid wood, laminated wood-based products, such as veneer boards and chip-boards, MDF boards and boards of mineral wool and plaster.

### TECHNICAL FIELD

The present invention relates to a composition for surface treatment of surfaces in the form of a surface treating agent in liquid form, such as UV curing lacquer which contains fillers.

The invention also relates to the use of the composition for pre-treatment of faces and/or edges on plate-shaped elements.

### THE PRIOR ART

In the furniture and wood industries it is known to use primers or sealers, e.g. in the form of acrylic-based lacquers for pre-treatment of edges and surfaces on boards, e.g. solid wood boards, veneer boards or porous boards, e.g. chipboards or MDF boards (MDF=Medium Density Boards), and boards made of rock wool and plaster. The pre-treatment serves to create an even surface having a good adhesion power for the possible sub-sequent finishing treatment(s).

After the application of the first layer of e.g. lacquer, the boards will normally be ground with sandpaper, band grinders or the like, following which treatment and grinding may be repeated once or several times. After completed treatment, one or more terminating layers of paint, lacquers, etc. may be applied to the pre-treated surfaces. Alternatively, the surfaces and/or the edges may be coated with paper, laminate, ABS plastics, hot foil or similar surfaces to achieve the finished boards. The treated boards may then be processed further for articles of furniture, tabletops, floor covering, etc.

During the pre-treatment, the small holes in the porous surfaces and edges are filled with lacquer, which is cured subsequently by generally known methods of curing, e.g. under illumination with ultraviolet (UV) light.

An example of a system for the (pre)treatment of particularly edges on porous and solid boards with lacquer can be found in WO 99/51361 A1.

The known lacquers for the pre-treatment of porous boards, including partitularly UV curing lacquers, however, have the drawback that they are relatively expensive, which means that the initial surface treatment of surfaces and edges, in particular on porous boards, constitutes a relatively high share of the production price of the finished product, since cavities in the porous surfaces and edges are filled with the expensive lacquer during the pre-treatment process.

It is known to use glass particles in surface treating agents to give the surface treating agents UV absorbing properties, see US 2005/0147571 A1, as well as to achieve a scratch resistant surface, see EP 1319524 A1. However, the documents are silent as to whether the addition of the glass particles has or may have importance to the curing process of particularly UV curing resin compositions.

### THE OBJECT OF THE INVENTION

The present invention wants to provide a liquid surface treating agent, including e.g. UV curing acrylic-based lacquer, which is les expensive in use than the known acrylic-based lacquers because of lower production costs by the use of inexpensive fillers, which is also friendly to the environment and the working environment, and which moreover does not contribute to environmental problems, and consequently stricter requirements with respect to treatment as dangerous waste, when the surface-treated products are to be disposed of or destroyed after completed use. Finally, it is desired to provide a surface treating agent which has low energy costs in the production, and which reduces the CO₂ contribution, or, at least, does not increase the contribution considerably relative to the known surface treating agents.

This is achieved in that the surface treating agent, as stated in claim 1, contains a film forming material and a filler. In particular, suitable fillers comprise a particulate material selected from inorganic salts or just called salt, chalk (CaCO₃), glass, plastics, wood flour or combinations of one or more of these. In particular as regards common salt, chalk and wood flour, these fillers are environmentally friendly and also inexpensive products.

The filler should be added in an amount which allows the film forming material, including in particular the acrylic-containing resin in UV curing acrylic-based lacquers, to cover the surfaces which are to be treated, but without affecting the adhesion and/or covering power of the surface treating agent. This makes it possible to use a reduced amount of the surface treating agent, including also the expensive UV curing lacquers, per m² treated surface, and a less expensive surface treatment process is achieved. Moreover, it has been found that the addition of fillers has a reduced wearing effect on after-treatment tools and grinding means.

As stated in claim 2, the particulate filler is advantageously present in an amount of 10-85%, in particular 25-80% and most preferably 40-75% (vol-%) of the total amount of surface treating agent. This achieves a good “dilution” of the film forming resin composition in the surface treating agent and thereby a great reduction in the price per m² treated surface, without the quality of the surface treatment being reduced noticeably relative to the use of a relatively expensive UV curing lacquer without filler.

The inorganic salt may e.g. be a sulphate, sulphite, phosphate, phosphonate, nitrate, halide or carbonate, or it may be the salt of a simple organic acid (less than 10 carbon atoms, e.g. 6 or less carbon atoms), such as citrate, malonate or acetate. Examples of cations in the inorganic salt include alkali or earth alkali metal ions; the ammonium ion and metal ions of the first transition series may also be used. Examples of preferred cations include sodium, potassium, magnesium, calcium, zinc and aluminium. Examples of preferred anions include chloride, bromide, iodide, sulphate, sulphite, bisulphite, thiosulphite, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, lactate, formate, acetate, butyrate, propionate, benzoate, tartrate, ascorbate and gluconate. In particular alkali or earth alkali metal salts of sulphate, sulphite, phosphate, phosphonate, nitrate, chloride and carbonate and salts of simple organic acids, such as citrate, lamonate or acetate are preferred. Specific examples of inorganic salts which may be used, include NaH₂PO₄, Na₂HPO₄, Na₃PO₄, (NH₄)H₂PO₄, K₂HPO₄, KH₂PO₄, NaₛSO₄, KₛSO₄, KHSO₄, ZnSO₄, MgSO₄, CuSO₄, M(NO₃)₂, (NH₄)₂SO₄, NaCl, talc (magnesium silicate), chalk (CaCO₃), magnesium acetate and sodium citrate.

It is preferred to use common salt (NaCl) as a particulate filler, particularly in UV curing surface treating agents, including in particular in UV curing lacquers, and especially in UV curing acrylic-containing lacquers, but the filler may also be used in other surface treating agents, including lacquers which are e.g. acid or heat curing. Surprisingly, it has been found that the curing process itself is not reduced in acceleration relative to the use of a UV curing lacquer without the filler. The reason is probably that the salt particles are transparent and may conduct and spread the UV light to the surrounding polymer phase. The addition of salt reduces the square metre price of the surface treatment considerably. It is also possible to use a less reactive UV curing acrylic-containing lacquer together with the filler, i.e. a lacquer with a slightly slower curing process, without the quality of the surface treatment being reduced noticeably relative to the use of an expensive UV curing lacquer without filler. This will also reduce the square metre price of the surface treatment additionally. It has been found at the same time that the tool life of grinding tools (grinding bands, etc.) is extended, when the porous boards are pre-treated with a UV curing acrylic-based lacquer with salt particles as a filler relative to the tool life of the grinding tools, when a UV curing acrylic-based lacquer without filler is used, and it is expected that this effect may also be observed when salt is used in other UV curing lacquers or other lacquers, including also acid or heat curing lacquers.

In addition, a uniformly cured surface is achieved in connection with porous surfaces, e.g. on MDF boards, chipboards, etc., as the cavities in the porous surfaces and edges are also filled sufficiently with surface treating agent, including the filler, and the polymer phase or the lacquer phase in the surface treating agent is also cured sufficiently right into the cavities in the porous surfaces. Finally, common salt is en environmentally friendly product, which does not affect the environment or the working environment to a noticeable degree.

A corresponding effect is seen with transparent plastics or glass particles, e.g. glass balls and glass fibres, and the effect may also be achieved with glass tissue.

It has also been found that e.g. chalk particles and other non-transparent particles or particles of lower transparency, e.g. plastics particles and wood flour, have a corresponding effect.

Preferably, the film forming resin composition comprises a UV curing acrylic-containing resin, including acrylic-based UV curing lacquers, or other UV curing resins, including lacquers. The filler is presumably also useful in other surface treating agents, e.g. acid curing or heat curing resins or lacquer systems.

Finally, it is expedient to use the surface treating agent for the pre-treatment, including lacquer priming of plate-shaped elements of solid wood, laminated wood-based products, including veneer boards, or porous wood-based material, including chipboards, optionally coated with veneer, MDF boards, etc.

The surface treating agent according to the invention may comprise clear compositions, i.e. lacquers, and pigmented compositions. The surface treating agents according to the invention are used particularly as primers or sealing base coats and will just be referred to as a surface treating agent or lacquer below.

The surface treating agent is particularly suitable as a primer or sealing layer on surfaces and edges of the above-mentioned wood-based boards which are used in the furniture, floor and wood industries.

The surface treating agent comprises a film forming resin composition and a filler. The film forming resin may be a heat and/or an acid curing resin, and the fillers according to the invention may be used in connection with most types of film forming resins, including also in adhesives.

However, the film forming resin composition preferably contains a UV curing resin and may e.g. comprise acrylic resins, polyester resins, polyurethane resins or graft polymers and/or mixtures thereof.

The surface treating agent may, and will frequently also, comprise other generally known ingredients within the dye-lacquer industry, such as agents for adjusting the viscosity and/or rheology of the mixture, surfactants, dispersion agents, pigments and curing agents or catalysts. In case of UV curing surface treating agents, e.g. one or more photoinitiators are normally added in order to initiate and/or accelerate the curing process.

According to the invention, a large number of commercially available surface treating agents, and in particular UV curing compositions, including lacquers, which are used especially in the field of surface treatment of wood, may be used according to the invention.

However, it is preferred to use an acrylic-containing UV curing lacquer, e.g. lacquer or paint, based on acrylic, acrylic polyester or acrylic polyurethane polymer compositions. According to the invention, it is moreover preferred that the UV curing lacquers are not water-based, in particular when the filler comprises salts particles. There are several commercially available UV curing acrylic-containing compositions which may be used as the film forming resin composition according to the invention.

Thus, it is possible to use a highly reactive UV curing primer in combination with the fillers according to the invention, where the expression highly reactive refers to the fact that the primer cures very rapidly. An example of such a highly viscous and highly reactive primer may be an non-aqueous, UV curing, highly viscous polyester acrylic lacquer, which contains inter alia 50-75% polyester acrylate, 0.1-1% 2,2′-oxydiethyl diacrylate, 0.1-1% hydroxy ethyl acrylate as well as 2.5-10% oligotriacrylate, e.g. glycerol, propoxylated, esters with acrylic acid (EC No. 500-114-5; CAS RN 52408-84-1) (weight-%).

It is also possible to replace the highly reactive primer by a less reactive lacquer in combination with the fillers according to the invention, without the quality of the surface treatment or the base treatment being affected noticeably relative to the use of an expensive highly reactive primer or lacquer without fillers. An example of such a low-reactive UV curing primer may be an non-aqueous, highly viscous acrylic-containing lacquer or primer which contains 10-25% diacrylate, preferably oxybis(methyl-2,1-ethanediyl)diacrylate, 3.5-10% photoinitiators, preferably 2.5-10% 2,2-dimethoxy-1,2-diphenylethane-1-one and 1-2.5% benzophenone as well as 10-25% oligotriacrylate, e.g. glycerol, propoxylated, esters with acrylic acid (EC No. 500-114-5; CAS RN 52408-84-1) (weight-%). Another example of a suitable low-reactive, UV curing primer which may be used according to the invention, is an non-aqueous highly viscous acrylic-containing lacquer which contains 10-25% oxybis(methyl-2,1-ethanediyl)diacrylate as well as 10-25% oligotriacrylate, e.g. glycerol, propoxylated, esters with acrylic acid (EC No 500-114-5; CAS RN 52408-84-1) (weight-%).

The fillers comprise particulate material selected from common salt (NaCl), chalk (CaCO₃), glass, plastics, wood flour or combinations thereof, and addition thereof will result in a significantly less expensive square metre price of the surface treatment, which are also environmentally friendly, and which do not involve significant environmental problems, when the surface-treated product is to be disposed of as waste after completed use.

When, e.g. UV curing acrylic-based lacquer containing filler, e.g. salt, is applied to surfaces and/or edges on e.g. chipboards, MDF boards, the small cavities in the porous surfaces and edges of the boards will be filled with the polymer mass/lacquer mass, including the filler. Since the filler constitutes a significant part of the surface treating agent, the fillers also fill a significant part of the volume in cavities and pores in the surfaces and edges of the boards, and it is possible to use a correspondingly smaller amount of the expensive acrylic-based lacquer or primer.

It is preferred that the particulate filler is common salt (NaCl), since salt is readily available, inexpensive and environmentally friendly. Salt is a transparent crystalline particulate material, which is very suitable as a filler in surface treating agents of the above-mentioned type, and which has been found to be particularly suitable as a filler in UV curing acrylic-based lacquers. Salt may be added in the form of particles, e.g. prism-shaped, cubic or ball-shaped crystals, and a moderate to high content of salt particles may be added to the surface treating agent, without reducing the curing, adhesion and/or covering power of the surface treating agent, since the transparent particles, including salt particles, are suitable for conducting the UV light and spreading it in all directions. When salt is used as a filler in an acrylic-containing lacquer, the salt particles are encapsulated in a film of lacquer. This means that the salt in the primer layer is not dissolved, which might be expected when, subsequently, a water-based topcoat, including a clear or pigmented lacquer, is used for the finishing treatment or the topcoat.

It is also possible to use particles or crystals of other salts, preferably transparent salts, it being taken into consideration that the product on which the surface treating agent containing the salts is used, should be disposable as ordinary combustible waste and not as environmentally dangerous waste. Thus, the salts should not comprise ions which may involve environmental problems at the disposal or may involve working environment problems.

Other transparent fillers which also exhibit this effect, are e.g. transparent plastics or glass particles, including also plastics or glass balls, as well as fibres or tissue of glass or plastics which have been torn and granulated to small particles.

It is not essential to the invention that a specific type of glass material is selected for the particles, but it has been found that glass particles used as blowing agents, e.g. in the surface treatment of aluminium, are suitable as fillers. Glass particles may also be used as fillers in water-based acrylic-containing lacquers, including also UV curing water-based acrylic lacquers. Nor is it essential to the invention that a specific type of plastics is used for the particles. However, it is necessary that the fillers of plastics used cannot absorb the surface treating agent or swell or be dissolved therein.

The transparent fillers are particularly suitable for transparent surface treatment systems, including priming or sealing lacquers.

Other suitable fillers are non-transparent fillers, e.g. chalk powder, plastics of less transparency or wood flour.

The transparent as well as the less transparent fillers are particularly suitable in connection with pigmented surface treatment systems, including particularly primers below pigmented topcoats, and primers for the treatment of boards which are processed further in another manner, as, after priming, the surfaces and/or the edges are coated with paper, laminate, ABS plastics, hot foil or the like.

Advantageously, the fillers may be added in an amount of 10-85%, in particular 25-80% and preferably 40-75% (vol-%) of the finished surface treating agent, without the quality of the surface treatment being reduced noticeably relative to the use of a more expensive UV curing lacquer without filler.

Advantageously, common salt may be added in an amount of 40-80 vol-%, and it is particularly preferred to add 55-75 vol-%, including especially about 70 vol-%; advantageously, chalk powder may be added in an amount of 40-70 vol-%, and it is particularly preferred to add 45-60 vol-%, including especially about 50 vol-%; advantageously, glass particles or a granulated woven glass material may be added in an amount of 40-80 vol-%, and it is particularly preferred to add 45-65 vol-%, including especially 50-60 vol-%; advantageously, plastics may be added in an amount of 40-80 vol-%, and it is particularly preferred to add 55-75 vol-%, including especially 60-70 vol-%; advantageously, wood flour may be added in an amount of 40-80 vol-%, and it is particularly preferred to add 40-50 vol-% (all percentages are expressed as vol-% of the finished surface treating agent).

The particle size of the fillers should be below about 400 μm, as larger particles cannot penetrate into the cavities and the openings in the porous surfaces and edges of the boards to a sufficient extent. It is preferred that the size of the particles is between 20 and 300 μm, since, otherwise, it is possible that the particles will be visible after finished surface treatment, in particular when used in transparent treatment systems. It is preferred that the particle size of salt particles is 50-300 μm, e.g. 125-300 μm, and especially 100-150 μm. It is preferred that the particle size of glass and plastics particles is 50-300 μm, and especially 50-250 μm. It is preferred that the particle size of wood flour is below 400 μm and is preferably 300-360 μm.

It is preferred that the fillers are added in the form of e.g. round or edged, e.g. cubic or prism-shaped, particles or granulates, and for fillers of plastics and glass it is also possible to use granulated particles of fibres or a woven glass or plastics material.

The surface treating agent according to the invention is particularly suitable for the treatment of edges and faces on solid wood boards, laminated wood boards, veneered shipboards, etc., and may e.g. be applied to the edges of the porous boards with a system like the one described in WO 99/51351 A.

It is possible to use generally known roller application machines for applying the surface treating agent to the surfaces of the porous boards. Then, the lacquer cures, preferably under UV illumination with a gallium (Ga) and/or a mercury (Hg) lamp and/or optionally with an iron (Fe) lamp.

### DETAILED DESCRIPTION OF THE INVENTION

A detailed description of the invention as well as working examples of the invention will be explained more fully below with reference to the drawing, in which

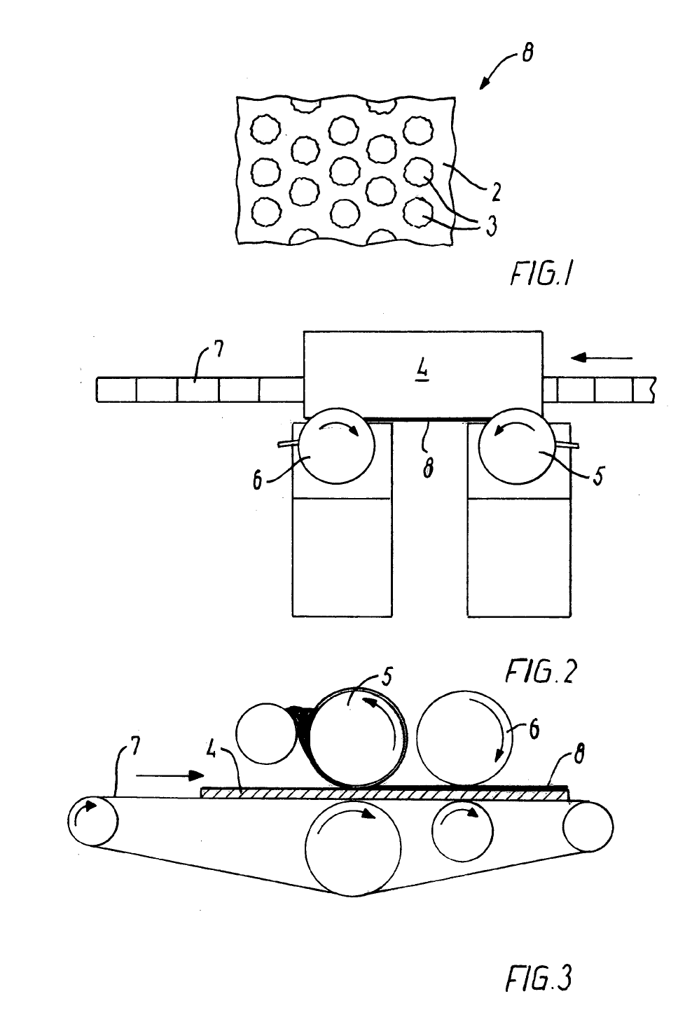

FIG. 1 shows a basic sketch in the form of an enlarged view of the surface treating agent, in which particles of fillers according to the invention are dispersed, and

FIG. 2 shows a known system according to WO 99/51361 A1 for surface treatment of edges on porous boards with UV curing lacquer, and

FIG. 3 shows an example of surface treatment of the surface of a board.

### EXAMPLE 1

An non-aqueous, highly viscous, clear, UV curing acrylic lacquer “highly reactive” is mixed with salt (NaCl) particles in a mix proportion of 30% acrylic lacquer and 70% salt (vol-%). This is illustrated in FIG. 1, where the lacquer 2 is shown mixed with salt crystals 3.

The UV curing acrylic-containing lacquer used is “UV solid edge 1153”, which is sold by AkzoNobel®, and which contains 50-75% polyester acrylate, 0.1-1% 2,2′-oxydiethyl diacrylate, 0.1-1% 2-hydroxy ethyl acrylate as well as 2.5-10% oligotriacrylate in the form of glycerol, propoxylated, esters with acrylic acid (EC No. 500-114-5; CAS RN 52408-84-1) (weight-%).

The salt is ordinary industrial salt with ball-shaped particles and a particle size in the range of 50-300 μmμ, which is sold e.g. by AkzoNobel.

### EXAMPLE 2

A clear, non-aqueous, UV curing acrylic lacquer with a lower curing rate (“low-reactive”) is mixed with salt (NaCl) particles in a mix proportion of 30% acrylic lacquer and 70% salt (vol-%).

The UV curing acrylic-containing lacquer used is “UV SEALER 2780”, which is sold by AkzoNobel®, and which contains 10-25% diacrylate, preferably oxybis(methyl-2,1-ethanediyl)diacrylate, 2.5-10% 2,2-dimethoxy-1,2-diphenylethane-1-one and 1-2.5% benzophenone as well as 10-25% oligotriacrylate in the form of glycerol, propoxylated, esters with acrylic acid (EC No. 500-114-5; CAS RN 52408-84-1) (weight-%).

The salt is of the same type as was used in example 1, but with a particle size in the range of 125-300 μm.

### EXAMPLE 3

A clear, non-aqueous, UV curing acrylic lacquer with a lower content of photoinitiators (“highly reactive”) is mixed with glass particles in a mix pro-portion of 40% acrylic lacquer and 60% glass particles (vol-%).

The UV curing acrylic-containing lacquer used is “UV solid edge 1153”, which is sold by AkzoNobel®, and which was also used in example 1.

The glass particles are ball-shaped with a particle size in the range of 50-250 μm.

### EXAMPLE 4

A UV curing acrylic lacquer with salt balls as fillers corresponding to the mixture made in example 1 is applied to a test board, in which standardized holes of a length of 6 mm, a width of 3 mm and a depth of 4 mm are made in the edge.

The mixture is applied to the edge of the board in a system of the type shown in FIG. 2 and described in WO 99/51361 A, in which the application rate (the speed of the board through the system) is about 22 m/min.

The lacquer 8 is applied by means of an application wheel 5 and is smoothed by a following wheel 6.

After completed application, the acrylic lacquer cures under UV illumination, as the edge of the board first passes a gallium lamp and then a mercury lamp in combination for UV illumination. The surface of the edge of the test board cures immediately under the UV illumination, and at a later inspection the finish-treated test board exhibits a surface where the holes are closed completely by lacquer, and all the lacquer has cured.

FIG. 3 shows an example of surface application of lacquer to a board 4. The board is advanced in the direction of the arrow on a belt 7, and the surface agent is fed to a roller 5 which applies a layer 8, said layer being smoothed by a smoothing roller 6. After the application, the lacquer 8 cures in a generally known manner.

### EXAMPLE 5

The experiment in example 4 was repeated with a mixture of UV curing acrylic lacquer with salt balls as fillers as made in example 2.

Here too, the finish-treated test board exhibits a surface where the holes are closed completely by lacquer, and all the lacquer has cured.

### EXAMPLE 6

The experiment in example 4 is repeated with a mixture of UV curing acrylic lacquer with glass balls as fillers as made in example 3.

Here too, the finish-treated test board exhibits a surface where the holes are closed completely by lacquer, and all the lacquer has cured.

### EXAMPLE 7

The experiment in example 4 is repeated with a traditional clear UV curing acrylic lacquer without added fillers and corresponding to the acrylic lacquer which is used for the mixture in example 1.

Here too, the finish-treated test board exhibits a surface where the holes are closed completely by lacquer, and all the lacquer has cured.

### EXAMPLE 8

Wear on tools from the treated surfaces is examined with test boards which have received a surface treatment corresponding to the treatments in examples 4-7, there being used a traditional grinding band on the treated surfaces which is subsequently inspected for wear.

The surface on test boards from examples 4-5 (with a lacquering containing salt particles) exhibited wear on the tools which was less than the wear from corresponding test boards with the traditional lacquer without filler particles (example 7). The tool life of the tools used for subsequent treatment of the boards, including particularly grinding bands, is thus extended when the boards are pre-treated with a UV curing acrylic lacquer containing salt particles.

1. A surface treating agent in liquid form, containing a film forming resin composition with additives in the form of fillers, characterized in that the filler comprises a particulate material selected from inorganic salts, chalk (CaCO₃), glass, plastics, wood flour or combinations thereof.

2. A surface treating agent according to claim 1, characterized in that the filler has a particle size of below 400 μmμ.

3. A surface treating agent according to claim 1, characterized in that the filler is present in an amount of 10-85 vol-%, in particular 25-80 vol-% and preferably 40-75 vol-% of the surface treating agent (8).

4. A surface treating agent according to claim 1, characterized in that the filler comprises common salt.

5. A surface treating agent according to claim 4, characterized in that the particle size of common salt is 50-300 μm, preferably 125-300 μm, including especially 100-150 μm.

6. A surface treating agent according to claim 4, characterized in that common salt is present in an amount of 40-80 vol-%, preferably 55-75 vol-% and especially 40-75% of the surface treating agent.

7. A surface treating agent according to claim 1, characterized in that the filler comprises chalk powder.

8. A surface treating agent according to claim 7, characterized in that the chalk powder is present in an amount of 40-70 vol-%, preferably 45-60 vol-% and especially 50 vol-% of the surface treating agent.

9. A surface treating agent according to claim 1, characterized in that the filler comprises glass, plastics and/or wood flour.

10. A surface treating agent according to claim 1, characterized in that the filler comprises particles and/or granulates of glass.

11. A surface treating agent according to claim 9, characterized in that the glass particles and/or the glass granulates are present in an amount of 40-80 vol-%, preferably 45-65 vol-% and especially 50-60 vol-% of the surface treating agent.

12. A surface treating agent according to claim 1, characterized in that the filler comprises particles and/or granulates of plastics.

13. A surface treating agent according to claim 9, characterized in that the plastics particles and/or the plastics granulates are present in an amount of 40-80 vol-%, preferably 55-75 vol-% and especially 60-70 vol-% of the surface treating agent.

14. A surface treating agent according to claim 9, characterized in that the particle size of the filler is 50-300 μm and especially 50-250 μm.

15. A surface treating agent according to claim 1, characterized in that the filler comprises particles of wood flour.

16. A surface treating agent according to claim 15, characterized in that wood flour is present in an amount of 40-80 vol-%, including preferably 40-50 vol-% of the surface treating agent .

17. A surface treating agent according to claim 15, characterized in that the particle size of the filler is below 400 μm, preferably 300-360 μm.

18. A surface treating agent according to claim 1, characterized in that the film forming resin composition is UV curing.

19. A surface treating agent according to claim 1, characterized in that the film forming resin composition contains an acrylic-based resin.

20. A surface treating agent according to claim 1, characterized in that the film forming resin composition is heat curing or acid curing.

21. Use of a surface treating agent according to claim 1, characterized in that the use comprises application of the agent to faces and/or edges on plate-shaped elements of solid wood, of laminated wood-based products, including veneer boards, or porous wood-based material, including chipboards, MDF boards and of mineral wool and plaster.
